(19) United States
(12) Patent Application Publication
(10) Pub. No.: US 2025/0187360 A1
(43) Pub. Date: Jun. 12, 2025

(54) SMART AND SECURE LABEL STOCK

(71) Applicants: ARUN AGARWAL, Ghaziabad (IN); SONIA AGARWAL, Ghaziabad (IN)

(72) Inventor: ARUN AGARWAL, Ghaziabad (IN)

(21) Appl. No.: 19/059,735

(22) Filed: Feb. 21, 2025

Related U.S. Application Data
(63) Continuation-in-part of application No. 17/624,093, filed on Dec. 30, 2021.

(51) Int. Cl. B42D 25/328; B31D 1/02; B32B 7/06; B32B 7/12; B32B 15/12; B32B 37/08; B32B 37/12; B32B 37/24; B42D 25/373; B42D 25/387; B42D 25/47

(52) U.S. Cl. CPC B42D 25/328; B31D 1/021; B31D 1/027; B32B 7/06; B32B 7/12; B32B 15/12; B32B 37/08; B32B 37/12; B32B 37/24; B42D 25/373; B42D 25/387; B42D 25/47; B32B 2037/243; B32B 2255/12; B32B 2255/28; B32B 2307/4023; B32B 2307/7163; B32B 2307/748; B32B 2317/12; B32B 2519/00

(57) ABSTRACT

The present invention relates to a smart and secure label stock with security features. The present invention relates to a label stock produced from a substrate utilizing adhesive and liner materials and having a plurality of security features on the rear side of the substrate made using specialized inks and various authentication features for different applications.

### FIELD OF THE INVENTION

The present invention relates to a smart and secure label stock. More particularly, the present invention relates to a label stock produced from a substrate utilizing adhesive and liner material and having a plurality of security features on the rear side of the substrate made using specialized inks and various authentication features for different applications and a process of manufacturing thereof.

### BACKGROUND OF THE INVENTION

A label stock is a carrier commonly coated on one side with adhesive and usually printed on the other side. It can be a wide variety of papers, films, fabric, foils, etc. There are many types of label stocks namely puffy labels, litho, latex, foil, thermal. Puffy labels are made of water, gel, foam or air. Litho are one of the most common label stocks. Latex is flexible and better than the most standard litho labels. Foil has the shiny properties of a metal foil. Thermal label stock changes color (usually black) when heated. A heating element in the shape of letters or images can be used to create an image on the label. The stock type affects the type of ink that prints well on them.

The label stock is used for printing labels which may not have or have security features integrated in the label. The security labels are printed on the front side of the label stock and for authentication, these labels can be read with machine code readers or visible through naked eye. Generally, on the rear side of the label stock there is a pressure sensitive or heat sensitive or moisture sensitive adhesive using which it is affixed on any product. There are some labels which are tamper evident which upon any attempt of counterfeiting get tampered in a way that determines counterfeiting at some extent. However, there are some labels which are not tamper evident and, in that case, for counterfeiting it just needs to be peeled off from a product and pasted on other. Further, with the help of high-resolution printers the labels on front side of the label stock are susceptible of being copied. In this scenario, generally a user authenticates a product from the label on the front side and may end up buying a counterfeit product. Further, adding security features to labels printed on the front of label stock adds more and more cost to the label to make it secure printed label. In printing such labels, a huge amount of cost is spent in printing the label and certain amount is spent on purchasing a suitable label stock. All the product manufacturers in the market cannot bear the cost of such expensive labels.

EP1102702 describes a method, module and apparatus useful in the application of linerless labels to surfaces of elements so that conventional liner label applicators can be used with linerless labels. The module for adapting apparatus which strips liners from a label and applies labels to a substrate, the module enabling the apparatus to apply linerless labels, the module comprising: a source of linerless label sheet, a source of liner sheet, a roll for guiding the linerless label sheet after removal from the source of linerless label, a die cutter and an anvil roller defining an area through which linerless label sheet may move between said die cutter and anvil roller, a laminator roller adjacent to the anvil roller defining an area between the anvil roller and the laminator roller through which both liner sheet and cut-out linerless labels from the linerless label sheet may move between the anvil roller and the laminator roller to form a temporary support of the liner for said cut-out linerless label. The main drawback of the invention is that the label formed from this method and apparatus is very expensive.

EP579423 discloses a linerless label stock produced from a single substrate utilizing a coating machine by moving the substrate through the coating machine and applying a tie coating to the substrate first face, a release coating to the substrate second face, and a pressure sensitive adhesive to the tie coating. The tie coating comprises a dispersion of a pigment, such as silica, with a binder, such as polyvinyl alcohol. The substrate is cut to form individual labels, and is rolled up into a roll with the release coated second face on the outside of the roll. Printing may be applied to the substrate prior to coating, or to the release coating. The main drawback of the invention is that the process used to prepare the label stock is very complex. Hence, there had been attempts to make the label stock secure adding security features on both its sides, but has resulted into making the label stocks costly and complex in manufacture.

Therefore, there is a need of producing cost effective provisions to add security features in the labels and hence, there is a need of incorporating security features in the label stocks that help in providing additional security to the product against counterfeiting.

### OBJECT OF THE INVENTION

The main object of the present invention is to provide a smart and secure label stock produced from a substrate utilizing plurality of specialized inks, various authentication features, adhesive, and liner material for different/wide range of applications.

Another object of the present invention is to provide a smart and secure label stock with security features utilizing hidden images, taggants and specialized inks for coating the substrate.

Yet another object of the present invention is to provide a smart and secure label stock tamper evident holographic layer which masks the separate security features on rear side of the substrate made using specialized inks and various authentication features for different applications.

Yet another object of the present invention is to provide a smart and secure label stock with tamper evident metalized holographic effects.

Yet another object of the present invention is to provide a process of manufacturing a smart and secure label stock.

Still another object of the present invention is to provide an assembly for providing the smart and secure label stock having various security features.

### SUMMARY OF THE INVENTION

The present invention relates to a smart and secure label stock with security features. More particularly, the present invention relates to a label stock produced from a substrate utilizing adhesive and liner materials with a plurality of specialized inks intended for different applications and process of manufacturing the same.

In an embodiment, the present invention provides a smart and secure label stock with security features comprising a substrate, a plurality of coating material, a sensitive adhesive, a release coat, a cold foil adhesive, a tamper evident holographic layer and a release paper wherein the security features are added on the rear side of the substrate. The substrate is preferably biodegradable such as a paper substrate including but not limited to chrome, art and maplitho paper. The coating material is coated on a specific area of the substrate forming a plurality of separate security features on separate portions using a plurality of specialized inks. The coating material includes specialized inks wherein the specialized inks include but are not limited to thermo-chromic ink, UV fluorescent ink, bi-chromic ink, a color ink, and a taggant.

In another embodiment, the present invention provides a process of manufacturing a smart and secure label stock comprising of: (a) lifting a specialized ink from a material tray by material lifting roller; (b) transferring lifted specialized ink into an ink transfer roller; (c) transferring ink to a pattern on a die/printing plate mounting roller; (d) transferring ink pattern to a substrate by an impression roller; (e) drying the substrate with ink pattern by passing through dry chamber; (f) coating the substrate with a plurality of coating material and a release coat on specified area using a plurality of ink and chemical coating stations following step (a) to (e); (g) coating a cold foil adhesive on the substrate to obtain adhesive coated substrate; (h) layering the adhesive coated substrate with metalized sheet roll and drying using drying chamber to form metalized substrate to give metalized registered tamper evident metalized holographic effect; (i) passing the metalized substrate through a rewind shaft to form a roll of metalized substrate; (j) unwinding release paper from release paper unwind shaft and passing through adhesive header for coating with a sensitive adhesive; (k) unwinding the metalized substrate and adhesive coated release paper and passing through the chilled sandwich rollers to stick together and form smart and secure label stock.

In yet another embodiment, the present invention provides an assembly for manufacturing the label stock includes a plurality of ink and chemical coating stations spaced from each other, a metal transfer station and a release lining station. The plurality of ink and chemical coating stations comprise of: a material tray, a plurality of rollers and a drying chamber. The ink and chemical coating station is used for coating the substrate with a plurality of specialized inks and a release coating chemical and drying the substrate. The plurality of rollers include but are not limited to material lifting roller, ink transfer roller, die/printing plate mounting roller and an impression roller. The specialized inks include but are not limited to a thermo-chromic ink, a bi-chromic ink, a UV fluorescent ink, a color ink and a taggant. The metal transfer station is also having a plurality of rollers, and an unwind and wind shaft carrying a metalized sheet roll for giving a registered tamper evident metalized holographic effect on the substrate. A release lining station having a plurality of unwinding shafts carrying a release paper roll and a coated substrate roll, an adhesive header and at least two sandwich rollers for lining the release paper with adhesive and sandwiching the adhesive coated release paper with the substrate forming the label stock and a rewind shaft for collecting the smart and secure label stock.

In yet another embodiment, the smart and secure label stock ensures the authenticity of the product due to the security features made using specialized inks and registered tamper evident holographic layer which has masking effect on the rear side of the substrate. The specific masking effect on the rear side of the substrate provides an extra edge to the label stock where the identification of security features cannot be revealed and thereby obviate the counterfeit of the product. The registered tamper evident metalized holographic effect on the rear side of the substrate ensures the authentication of the product because as soon as smart and secure label stock is peeled off from the product, the pattern made using metalized fumes is tampered on the product cannot be reused again. Due to this tampering, the smart and secure label stock becomes unusable and prevents counterfeiting. Further, the separate security features made using specialized inks include a text, an art work or a raster image that becomes readable on the back side of the substrate and some security features are read through special readers or film. Raster images are images stored in varying formats which are technically characterized by the width and height of image in pixels and by number of bits per pixel (or color depth, which determines the number of colors it represents). Raster images are non line art images and include subtle chromatic gradations, undefined lines and shapes and complex composition.

### BRIEF DESCRIPTION OF THE DRAWING

Some embodiments of the present invention are illustrated as an example and are not limited by the figures of the accompanying drawings, in which like references may indicate similar elements and in which:

FIG. 1 depicts the ink and chemical coating station in accordance with an embodiment to the present invention.

FIG. 2 depicts the metal transfer station in accordance with an embodiment to the present invention.

FIG. 3 depicts the release lining station in accordance with an embodiment to the present invention.

FIG. 4 shows the smart and secure label stock in accordance with an embodiment to the present invention.

FIG. 5 shows images of the smart and secure label stock at different stages in accordance with the present invention.

### DETAILED DESCRIPTION OF THE INVENTION

The present invention will now be described hereinafter in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

The present invention relates to a smart and secure label stock with security features. More particularly, the present invention relates to the label stock produced from a substrate utilizing adhesive and liner materials with specialized inks for different applications.

In a preferred embodiment, the present invention provides a smart and secure label stock with security features comprising a substrate, a plurality of coating material, a pressure or heat or moisture sensitive adhesive, a release coat, a cold foil adhesive, a tamper evident holographic layer and a release paper wherein the security features are added on the rear side of the substrate. The substrate is biodegradable and preferably a paper substrate including but not limited to chrome, art and map litho paper. The coating material and release coat is coated on a specific area of the substrate forming a plurality of separate security features on separate portions using a plurality of specialized inks. The coating material includes specialized inks wherein the specialized inks including but not limited to thermo-chromic ink, UV fluorescent ink, bi-chromic ink, a color ink, and a taggant. The release coat includes but is not limited to silicone. The specialized inks are used to create a plurality of security features such as a text, an artwork, a raster image etc. The bi-chromic ink coated on the substrate is a two color UV ink and is visible in two UV lights out of which one is high wavelength UV light and other is low wavelength UV light.

In yet another embodiment, the present invention provides an assembly for manufacturing the label stock includes a plurality of ink and chemical coating stations spaced from each other, a metal transfer station and a release lining station. The plurality of ink and chemical coating stations comprise of: a material tray, a plurality of rollers and a drying chamber. The ink and chemical coating station is used for coating the substrate with a plurality of specialized inks and a release coat chemical and drying the substrate. The plurality of rollers include but are not limited to material lifting roller, ink transfer roller, die/printing plate mounting roller and an impression roller. The specialized inks include but are not limited to thermo-chromic ink, bi-chromic ink, UV fluorescent ink, color ink and a taggant. The metal transfer station is also having a plurality of rollers and an unwind and wind shaft carrying a metalized sheet roll for giving a registered tamper evident metalized holographic effect on the substrate and a release lining station having a plurality of unwinding shafts carrying a release paper roll and a coated substrate roll, an adhesive header and at least two sandwich rollers for lining the release paper with adhesive and sandwiching the adhesive coated release paper with the substrate forming the smart and secure label stock and a rewind shaft for collecting the smart and secure label stock.

In the ink and chemical coating station, the material lifting roller (conveyer sheet) is used to lift the ink from the material tray and transfers the lifted ink to the corresponding ink transfer roller. The ink transfer roller transfers the ink to the pattern on the corresponding die/printing plate mounting roller and the printed pattern is printed or coated on the rear side of the paper substrate by using the impression roller. After coating with specialized inks, the substrate is passed to the drying chamber where the substrate is dried properly. The substrate after passing through a plurality of ink and chemical coating stations gets winded to the rewind shaft.

The rewind shaft gets unwound into the metal transfer station having a plurality of rollers and an unwind and wind shaft carrying a metalized sheet roll for giving a registered tamper metalized holographic effect on the substrate. The substrate is passed through the plurality of rollers to transfer an adhesive on the substrate in a pattern. A metalized sheet roll from an unwind shaft then comes into contact with the substrate applied with the adhesive. The metal fumes from the metalized sheet roll then stick to the substrate and thereafter the metalized substrate is dried and cured in the drying chamber.

The metal fumes give the substrate a registered tamper evident metalized holographic effect and hence the metalized substrate is wound back to a rewind shaft. On the other hand, the used up metalized sheet roll is wound on the corresponding rewind shaft. The rewind shaft with metalized substrate gets unwound into the release lining station where it is sandwiched with an adhesive coated release paper through chilled sandwich rollers and finally forms the smart and secure label stock. Plurality of unwinding shafts carries a release paper roll and a coated substrate roll. The release paper is coated with adhesive using the adhesive header in the release lining station.

The smart and secure label stock ensures the authenticity of the product due to the security features made using specialized inks and registered tamper evident holographic layer which has masking effect on the rear side of the substrate. The specific masking effect on the rear side of the substrate provides an extra edge to the label stock where the identification of security features cannot be revealed and thereby obviate the counterfeit of the product. The registered tamper evident holographic layer have various effects which include metalized holographic effect or plain paper effect or mono or multicolour effect or any printing effect on the rear side of the substrate ensures the authentication of the product because as soon as smart and secure label stock is peeled off from the product, the pattern made using metalized fumes or any other form is tampered on the product cannot be reused again. Due to this tampering the smart and secure label stock becomes unusable and prevents counterfeiting. Further, the security features made using specialized inks such as any text, art work or raster image become readable on the back side of the substrate and some security features are read through special readers or film. Raster images are images stored in varying formats which are technically characterized by the width and height of image in pixels and by number of bits per pixel (or color depth, which determines the number of colors it represents). Raster images are non line art images and include subtle chromatic gradations, undefined lines and shapes and complex composition.

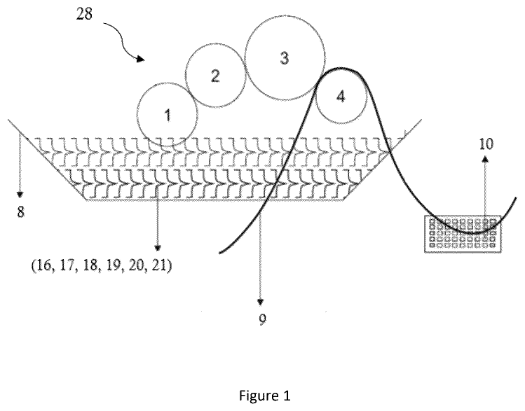

Now referring to FIG. 1, the ink and chemical coating station is shown. The ink and chemical coating station (28) has a material tray (8) in which a specialized ink is filled including but not limited to thermo-chromic ink, UV fluorescent ink, bi-chromic ink, taggant, and an ink for making a hidden raster image and other security features. The material lifting roller (1) lifts the specialized ink from the material tray (8) and transfers the lifted ink into the ink transfer roller (2) from where the ink is transferred to pattern on the die/printing plate mounting roller (3) and the printed pattern is transferred to the substrate (9) by using an impression roller (4). Finally, the substrate (9) with ink coated on it is sent to the drying chamber (10) where it is dried properly. The substrate (9) after passing through the ink and chemical coating station winds back to the rewind shaft or continuous with the material tray (8). The substrate (9) is coated with a plurality of coating material (16, 17, 18, 19, and 20) and a release coat (21) by using a plurality of ink and chemical coating stations having separate inks filled in the material tray (8).

The thermo-chromic ink is a type of ink that turns transparent when heat is applied. The UV fluorescent ink is an invisible ink with fluorescent properties and can be read under ultraviolet radiations. The bi-chromic ink is a two color ink UV ink and seen under two special UV lights namely short wavelength UV light and long wavelength UV light. The taggant is an invisible ink that does not have any color and reacts with specially designed camera, light and scanner. The ink is also in the form of a hidden raster image with specifically digitized photographs, artworks, undefined lines and shapes, complex composition, subtle chromatic gradations and graphics. The inks are coated on the substrate on a specified area for security purpose.

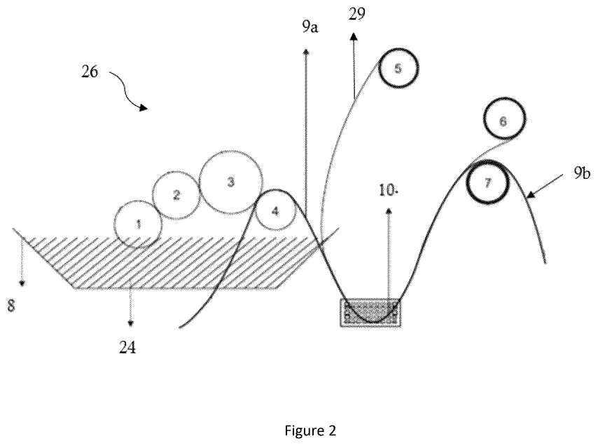

Now referring to FIG. 2, the metal transfer station is shown. The metal transfer station (26) allows the substrate (9) to be coated with a cold foil adhesive (24) present in material tray (8) using the material lifting roller (1), ink transfer roller (2), die printing mounting roller (3), impression roller (4) to obtain adhesive coated substrate (9a). The adhesive coated substrate (9a) is layered with the metalized sheet roll (29) and dried using drying chamber (10) such that metal fumes stick to substrate (9) to form the metalized substrate (9a), giving the registered tamper evident metalized holographic effect. The metalized substrate (9b) then passes through the rewind shaft (7) to form a roll of metalized substrate (9b). The metalized sheet roll (29) is unwound from an unwind shaft (5) and after metalization, the used up metalized sheet roll (29) is wound again to rewind shaft (6).

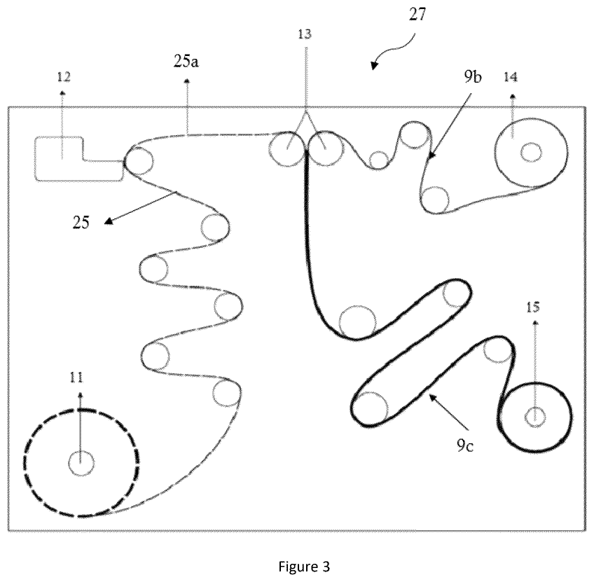

Now referring to FIG. 3, the release lining station (27) is shown having the adhesive header (12) and chilled sandwich rollers (13). The release paper (25) unwinds from the release paper unwind shaft (11) and passed through the adhesive header (12) from where the release paper (25) is coated with a sensitive adhesive (22). The unwind shaft (14) on the other hand, unwinds the metalized substrate (9a) and both the adhesive coated release paper (25a) and the metalized substrate (9a) is passed through the chilled sandwich rollers (13) where they are sandwiched together to form the smart and secure label stock (9c) and winds into the rewind shaft (15).

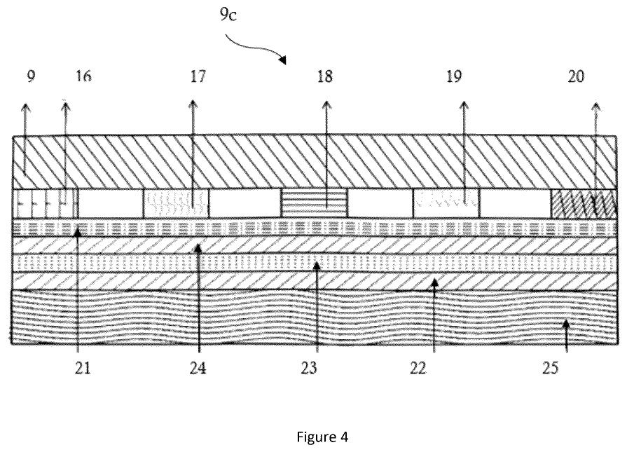

Now referring to FIG. 4, the smart and secure label stock is shown. The label stock comprises of a substrate (9) with a coating material, a release coat (21), a cold foil adhesive (24), a tamper evident holographic layer (23), a sensitive adhesive (22) and a release paper (25). The coating material is coated on a specific area of the substrate (9) forming a plurality of separate security features on separate portions using a plurality of specialized inks. The specialized inks include but not limited to thermo chromic ink (16), taggant (17), UV fluorescent ink (18), special ink (19) for raster image and bi chromic ink (20) to be coated on a specified area on the rear side of the substrate (9) forming the separate security features from the specialized ink. The release coat (21) is coated on the substrate (9) through an ink and chemical coating station. The cold foil adhesive (24) is coated on the substrate (9) and tamper evident holographic effect is given to the substrate (9) forming the tamper evident holographic layer (23) and finally the release paper (25) is attached on the substrate using a sensitive adhesive (22) forming the smart and secure label stock (9c).

The substrate (9) on its rear side is coated with the coating material (16, 17, 18, 19, 20 and 21) on a specified area in the ink and chemical coating station. The cold foil adhesive (24) over tamper evident holographic layer (23) is formed on the rear side of the substrate (9) making it a metalized substrate in the metal transfer station and finally a sensitive adhesive (22) coated release paper (25) is attached on the rear side of the metalized substrate to form the ready to use smart and secure label stock (9b) in the adhesive coating station. The smart and secure label stock is usable as a blank label after die-cutting to be affixed on any product over which anything can be written by hand or as a label stock over which a company label having its own security features are printed.

Referring to FIG. 1 to 4, in another embodiment, the present invention provides a process of preparing a smart and secure label stock comprising of: (a) lifting a specialized ink from a material tray (8) by material lifting roller (1); (b) transferring lifted specialized ink into an ink transfer roller (2); (c) transferring ink to a pattern on a die/printing plate mounting roller (3); (d) transferring ink pattern to a substrate (9) by an impression roller (4); (e) drying the substrate (9) with ink pattern by passing through dry chamber (10); (f) coating the substrate (9) with plurality of coating material and a release coat (21) on specified area using plurality of ink and chemical coating stations (28) filled with plurality of ink following step (a) to (e); (g) coating a cold foil adhesive (24) on the substrate (9) to obtain adhesive coated substrate (9a); (h) layering the adhesive coated substrate (9a) with metalized sheet roll (29) and drying using drying chamber (10) to form metalized substrate (9b) to give a registered tamper evident metalized holographic effect and obtain a tamper evident holographic layer (23); (i) passing the metalized substrate (9b) through a rewind shaft (7) to form a roll of metalized substrate (9b); (j) unwinding release paper (25) from release paper unwind shaft (11) and passing through adhesive header (12) for coating with a sensitive adhesive (22); (k) unwinding the metalized substrate (9b) and adhesive coated release paper (25a) and passing through the chilled sandwich rollers (13) to stick together and form smart and secure label stock (9c).

Here, the bond strength of cold foil adhesive (24) is lesser than the sensitive adhesive (22), such that while tampering any label printed on label stock (9c), when said label is pulled said sensitive adhesive tries to hold the tamper evident holographic layer (23) to itself and gets tampered as the release coat (21) is applied at specified locations, however the cold foil adhesive is uniformly applied over the release liner (25).

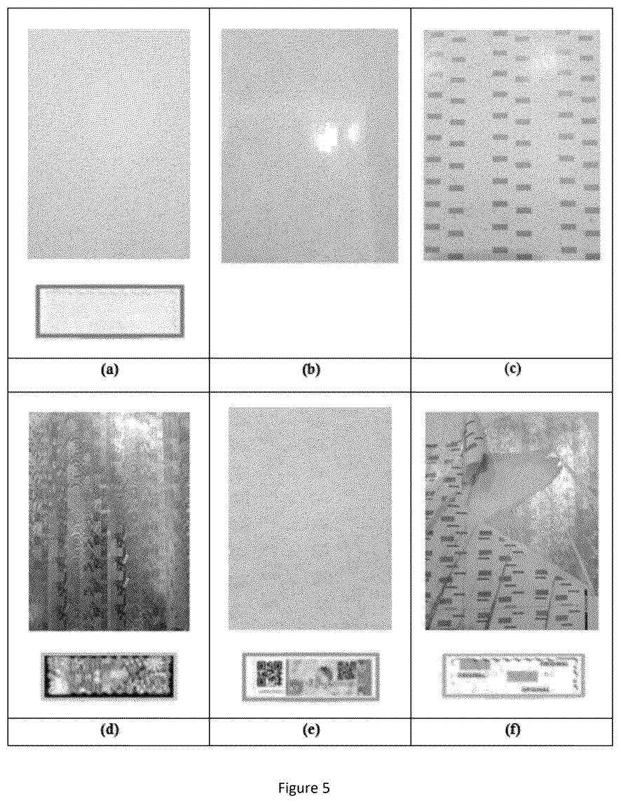

FIG. 5 shows images of the smart and secure label stock at different stages in accordance with the present invention. Part (a) of FIG. 5 shows a plain paper chosen as substrate to prepare the smart and secure label stock and the paper substrate including security cuts and edge cuts. Part (b) of FIG. 5 shows release paper over which the sensitive adhesive is applied to attach on the rear side of the substrate. Part (c) of FIG. 5 shows the substrate after being printed with some security feature on the rear side. Part (d) of FIG. 5 shows the substrate after the separate security features being covered with tamper evident holographic layer. Said tamper evident holographic layer may include 3D effect, CLR animation, pearl with channel, concealed animated image, Guilloche pattern, raster effect, micro text, kinetic and alike. Part (e) of FIG. 5 shows the smart and secure label stock obtained by pasting release paper with help of sensitive adhesive and substrate after printing and transfer of holography which may be blank on the front side or printed on the front side. Part (f) of FIG. 5 shows a smart and secure label stock pasted on any surface and then removed from it to see the separate security features hidden/written behind holography.

Therefore, the present invention provides a smart and secure label stock having a plurality of security features made on different portions in its rear side using a plurality of specialized inks and various authentication technologies. The present invention provides an added security feature for authentication of any product.

1. A smart and secure label stock (9c) comprising:
a substrate (9) having a front side and a rear side;
a plurality of coating material (16, 17, 18, 19, and 20);
a sensitive adhesive (22);
a release coat (21);
a cold foil adhesive (24);
a tamper evident holographic layer (23); and
a release paper (25);
wherein,
said smart and secure label stock (9c) has a plurality of separate security features added on said rear side of the substrate (9);
said plurality of coating material (16, 17, 18, 19, and 20) and said release coat (21) are coated on a specific area on the rear side of the substrate (9) and said plurality of coating material (16, 17, 18, 19, and 20) form said plurality of separate security features on the rear side of the substrate (9);
said cold foil adhesive (24) is coated to stick metal fumes from a metalized sheet roll (29) and form said tamper evident holographic layer (23);
said tamper evident holographic layer (23) masks the plurality of separate security features made using a plurality of coating material (16, 17, 18, 19, and 20);
said substrate (9) with the plurality of separate security features and said tamper evident holographic layer (23) is affixed with said release paper (25) provides a smart and secure label stock (9c) having a blank surface on the front side of the substrate (9).

2. The label stock (9c) as claimed in claim 1, wherein the substrate (9) is biodegradable and preferably a paper substrate including chrome, art and map litho paper.

3. The label stock (9c) as claimed in claim 1, wherein the plurality of coating material (16, 17, 18, 19, 20, 21) includes specialized inks including a thermo chromic ink (16), taggant (17), UV fluorescent ink (18), special ink (19) for raster image, bi-chromic ink (20) and said release coat (21).

4. The label stock (9c) as claimed in claim 1, wherein the plurality of separate security features includes a text, an artwork, a raster image, and partially visible features readable only using specialized readers.

5. The label stock (9c) as claimed in claim 1, wherein the bi-chromic ink (20) includes a two color UV ink visible in two UV lights out of which one is high wavelength UV light and other is low wavelength UV light.

6. The label stock (9c) as claimed in claim 1, wherein the label stock (9c) provides security to a product against counterfeiting through said plurality of security features made using specialized inks and said tamper evident holographic layer (23) includes a tamper evident metalized holographic layer or tamper evident plain layer or tamper evident mono or multicolour layer on the rear side of the substrate (9).

7. The label stock (9c) as claimed in claim 1, wherein the label stock (9b) is used either as a blank label or printed label affixed on the product.

8. The label stock (9c) as claimed in claim 1, wherein the sensitive adhesive (22) includes a pressure sensitive or heat sensitive or moisture sensitive adhesive.

9. The label stock (9c) as claimed in claim 1, wherein the cold foil adhesive (24) has a bond strength lesser than bond strength of the sensitive adhesive (22).

10. A process of manufacturing a smart and secure label stock (9c) comprising of:
(a) lifting a specialized ink from a material tray (8) by material lifting roller (1);
(b) transferring lifted specialized ink into an ink transfer roller (2);
(c) transferring ink to a pattern on a die/printing plate mounting roller (3) to obtain an ink pattern;
(d) transferring said ink pattern to a substrate (9) by an impression roller (4);
(e) drying the substrate (9) with said ink pattern by passing through dry chamber (10);
(f) coating the substrate (9) with a plurality of coating material and a release coat (21) on specified area through plurality of ink and chemical coating stations (28) filled with plurality of specialized ink and subsequently said release coat (21) following step (a) to (e);
(g) coating a cold foil adhesive (24) on the substrate (9) to obtain an adhesive coated substrate (9a);
(h) layering the adhesive coated substrate (9a) obtained in step (g) with a metallized sheet roll (29) and drying using drying chamber (10) to form a metalized substrate (9b) to give a tamper evident metalized holographic effect and obtain a tamper evident layer (23);
(i) passing the metallized substrate (9b) through a rewind shaft (7) to form a roll of metalized substrate (9b);
(j) unwinding release paper (25) from release paper unwind shaft (11) and passing through an adhesive header (12) for coating with a sensitive adhesive (22) to obtain an adhesive coated release paper (25a); and
(k) unwinding the metallized substrate (9b) obtained in step (i) and said adhesive coated release paper (25a) obtained in step (j) and passing through a set of chilled sandwich rollers (13) to stick together and form smart and secure label stock (9c).

11. The process of manufacturing a smart and secure label stock (9c) as claimed in claim 10, wherein said tamper evident holographic layer (23) creates a stronger bond with said sensitive adhesive (22) than the bond with cold foil adhesive (24) for tamper evidence.

12. The process of manufacturing a smart and secure label stock (9c) as claimed in claim 10, wherein said substrate (9) is coated with said plurality of coating material on specified area with plurality of specialized ink in step (f) to obtain a plurality of separate security features.
